(19) United States
(12) Patent Application Publication
(10) Pub. No.: US 2023/0407931 A1
(43) Pub. Date: Dec. 21, 2023

(54) BRAKE PAD FOR A DISK BRAKE SYSTEM AND DISK BRAKE SYSTEM

(71) Applicant: HL MANDO CORPORATION, Pyeongtaek-si (KR)

(72) Inventors: Hatem SHAHIN, Pfaffenhofen (DE); Andrea MEZZABOTTA, Eschborn (DE); Jan KALBAß, Schmitten (DE); Volker KINDER, Russelsheim (DE); Lothar WAGNER, Simmern (DE); Kai BRAUN, Friedrichsdorf (DE)

(21) Appl. No.: 18/210,367

(22) Filed: Jun. 15, 2023

(30) Foreign Application Priority Data
Jun. 21, 2022 (DE) 102022206184.5

(51) Int. Cl. F16D 65/092

(52) U.S. Cl. CPC F16D 65/092

(57) ABSTRACT

The application relates to a brake pad for a disk brake system and to a disk brake system. The proposed brake pad comprises a back plate having a front side for facing a brake disk of the disk brake system. The brake pad further comprises a friction layer arranged on the front side of the back plate for contacting a friction surface of the brake disk. Further, the brake pad comprises a pressure region that is configured to be pushed on by a brake piston or by a caliper finger of the disk brake system. The back plate and the friction layer each extend into the pressure region. The back plate has a reduced thickness in the pressure region as compared with a region of the brake pad that is not configured to be pushed on by the brake piston or caliper finger.

### CROSS-REFERENCE TO RELATED APPLICATION

This application is based on and claims priority under 35 U.S.C. § 119 to German Patent Application No. 102022206184.5, filed on Jun. 21, 2022 in the German Patent and Trade Mark Office, the disclosures of which are incorporated herein by reference.

### TECHNICAL FIELD

The application relates to a brake pad for a disk brake system and to a disk brake system.

### BACKGROUND

Brake Engineers are in search for robust solutions to suppress squeal noises (tonal loud noises typically appearing in frequencies between about 1000 and 12000 Hz) in disk brake systems. Different solutions are known to improve the noise, vibration, and harshness (NVH) characteristics, including a steel shim glued to a back side of a back plate of a brake pad assembly, different chamfers on a pad of the brake pad assembly, slots on pad surfaces contacting the disk, modifications of friction material of the brake pads, an underlayer connecting the friction material to the back plate, and additional massive bodies on certain components like a carrier or the housing. The main effect of the shim is to decouple system modes from each other. While these solutions can help improve the squeal noise characteristics, in most cases these solutions work well only under specific braking conditions (low or high frequency, cold or warm temperature). Also, noise generation may increase with time due to an inhomogeneous wear of the friction material. Prior art can be found, e.g., in document DE 197 06 122 A1.

### SUMMARY

In view of the above-mentioned aspects, it is an object of the present application to provide an improved brake pad for a disk brake system. In particular, it is an object of the application to provide a compact and robust brake pad with a low mass at a low cost, which reliably suppresses noise, in particular squeal noise. In addition, it is an object of the application to provide an improved disk brake system having these advantages.

This objective is achieved by a brake pad for a disk brake system comprising the features of claim 1 and by a disk brake system having the features of another claim. Optional further features and further developments will become apparent from the dependent claims and the detailed description in conjunction with the accompanying figures.

The proposed brake pad for a disk brake system comprises a back plate having a front side for facing a brake disk of the disk brake system. The brake pad further comprises a friction layer arranged on the front side of the back plate for contacting a friction surface of the brake disk. Further, the brake pad comprises a pressure region that is configured to be pushed on by a brake piston or by a caliper finger of the disk brake system. The back plate and the friction layer each extend into the pressure region. The back plate has a reduced thickness in the pressure region as compared with a region of the brake pad that is not configured to be pushed on by the brake piston or caliper finger.

The proposed brake pad may enable a reduction of the generation of squeal noises. By providing the reduced thickness of the back plate in the pressure region, beneficial pressure and force flow characteristics of the brake pad may be achieved. In particular, it was found that problems resulting from the compressibility of the friction layer may be overcome or reduced by using the proposed brake pad. In particular, a distribution of the braking pressure will be more constant in the contact area between the disk and the friction layer, thereby enabling a reduction of noise and an improvement of the braking performance. By providing the reduced thickness of the back plate in the pressure region, a sufficient compressibility of the friction material may be used to ensure a soft contact and additional noise dissipation while ensuring a homogeneous pressure distribution. Also, due to the fact that a homogenous pressure distribution of the friction material is ensured by the proposed brake pad, wear of the friction material may be more homogenous. Thereby, the generation of additional noise over time resulting from inhomogeneous wear of the brake pad may be avoided. Instead, uniform and plane contact faces between the disk and friction layer may be ensured to avoid static and dynamic issues. By way of the reduced thickness of the back plate in the pressure region, constant values for static and dynamic compressibility may be achieved for a variety of shapes of back plates and friction materials, wherein constant compressibility values may be achieved for the friction material in all three dimensions. The proposed brake pad enables compensation of the areas of higher pressure to match with the area of low pressure so that in total a thickness change due to compression is roughly constant over the area of the brake pad. Further, improving the dynamic properties of the brake pad and its back plate and friction layer has the advantage that noise properties are improved in the region that is highly important for noise transmission from the source of squeal noise (relative motion between disk and friction layer) to other components of the disk brake system and an axle assembly. The proposed brake pad constitutes a low cost, low mass and robust solution that reduces noise generation over a wide range of frequencies and temperatures. In some embodiments, additional means for noise reduction such as shims, chamfers and/or additional masses may not be required and may not be provided.

The application further relates to the disk brake system. The disk brake system may comprise a brake pad as described above or below. The disk brake system may further comprise a carrier. The brake pad may be configured to slide with respect to the carrier. The brake pad may be configured to slide with respect to the carrier in an axial direction upon brake application. The axial direction may be parallel to an axis of rotation of the brake disk. In most embodiments, the disk brake system is a floating caliper brake. The disk brake system may comprise the brake piston and/or the caliper finger. The brake piston or caliper finger may be configured to push against a back side of the brake pad to push the friction layer of the brake pad against the friction surface of the brake disk. The back side of the brake pad may be formed by a back surface of the back plate.

For particularly efficient noise reduction, a thickness of the back plate in the pressure region is at least 0.4 mm, in particular at least 0.5 mm, smaller than in the region of the brake pad that is not configured to be pushed on by the brake piston or caliper finger and/or a thickness of the back plate in the pressure region is at most 1.2 mm, in particular at most 1 mm, smaller than in the region of the brake pad that is not configured to be pushed on by the brake piston or caliper finger. The back plate typically has a part that is arranged within the pressure region and another part that is arranged outside of the pressure region. In most embodiments, the back plate has a uniform thickness in the pressure region. Additionally or alternatively, the back plate may have a uniform thickness in the region of the brake pad that is not configured to be pushed on by the brake piston or caliper finger. The parts of the back plate that that are arranged within and outside of the pressure region may hence at least in part have a homogeneous thickness. The parts of the back plate that that are arranged within and outside of the pressure region may be separated by a step in a surface of the back plate.

The front side of the back plate may have a surface, which may be non-flat. A shape of the surface of the front side of the back plate may result in the thickness of the back plate being reduced in the pressure region. For example, the front side of the back plate may have a recess that leads to a part of the back plate having a reduced thickness. In some embodiments, a step separating the part of the back plate that is arranged within the pressure region and the part of the back plate that is arranged outside of the pressure region may be formed on the front side of the back plate. The back plate may further have a back side. The back side of the back plate may be smooth and/or stepless. The part of the back plate that is arranged within the pressure region may have an essentially homogeneous thickness. Further, in some embodiments, the part of the back plate that is arranged outside of the pressure region may have an essentially homogeneous thickness. In some embodiments, the part of the back plate that is arranged within the pressure region and/or the part of the back plate that is arranged outside of the pressure region may be smooth and/or stepless. The part of the back plate that has the reduced thickness may have a width and/or height, e.g., as measured in a tangential and a radial direction, respectively, of at least 20 mm, in particular at least 50 mm, and/or at most 200 mm. Further, a part of the back plate that has an increased thickness may have a width and/or height, e.g., as measured in the tangential and the radial direction, respectively, of at least 20 mm, in particular at least 50 mm, and/or at most 200 mm. In typical embodiments, the back plate has a reduced thickness in the entirety of the region that is configured to be pushed on by the brake piston or by the caliper finger.

In most embodiment, the friction layer comprises an increased thickness in the pressure region as compared with the region of the brake pad that is not configured to be pushed on by the brake piston or caliper finger. Thereby, the noise reduction, wear and compressibility characteristics may be further improved. Typically, the friction layer has a part with an increased thickness in a region corresponding to the part of the back plate that has the reduced thickness. The part of the friction layer that has the increased thickness may in part be arranged within the recess formed on the front side of the back plate. To achieve efficient noise reduction, a thickness of the friction layer in the pressure region may be at least 0.4 mm larger than in the region of the brake pad that is not configured to be pushed on by the brake piston or caliper finger. Further, the thickness of the friction layer in the pressure region is typically at most 1 mm larger than in the region of the brake pad that is not configured to be pushed on by the brake piston or caliper finger. A part of the friction layer that has an increased thickness may be formed by a protrusion on a back side of the friction layer.

In some embodiments, the brake pad comprises an underlayer and/or an adhesive layer arranged between the back plate and the friction layer. The underlayer may have a thickness of at least 1 mm and/or at most 4 mm. In some embodiments, a total thickness of the back plate and the friction layer in the pressure region is the same as a total thickness of the back plate and the friction layer in the region of the brake pad that is not configured to be pushed on by the brake piston or caliper finger. Thereby, the friction layer and the back plate may have an essentially uniform total thickness in sum. The total thickness may include a thickness of the underlayer and/or adhesive layer, if provided.

In typical embodiments, the back plate and/or the friction layer is formed by a non-joined part. In particular, the part of the back plate and/or the friction layer that has an increased thickness may be formed by a non-joined one-piece part. In typical embodiments, the back plate is made of a metal. For example, the back plate may be made of steel, cast iron or aluminium. In some embodiments, the back plate may be made by a shell construction of metal combined with phenolic material. The parts of the back plate that have the reduced and increased thicknesses may be formed, e.g., by a cutting or a forging process. A maximal thickness of the back plate, e.g., a thickness in the region of the brake pad that is not configured to be pushed on by the brake piston or caliper finger, may be at least 3 mm and/or at most 8 mm, for example 5 mm.

In some embodiments, the back plate comprises a region of increased thickness as an outer frame. For example, a region of increased thickness, e.g., by at least 0.5 mm, for example about 1 mm, around an outer edge of the back plate may be provided.

In typical embodiments, the back plate comprises a guiding protrusion. The guiding protrusion may be configured to be slidably received within a guiding recess of the carrier. In typical embodiments, the back plate comprises a back plate body. The guiding protrusion of the back plate may protrude in a tangential direction from the back plate body. In this manner, the guiding protrusion may extend in a sideward direction and may define a leading or a trailing portion of the back plate or a part thereof. The back plate may comprise another guiding protrusion. The guiding protrusion may define a leading portion of the back plate, and the other guiding protrusion may define a trailing portion of the back plate.

The friction layer can comprise copper, iron sulphide, graphite, zinc powder, basalt, calcium carbonate, tin sulphide, zinc aluminium, phenolic resin, rubber dust and/or mineral fibre. The friction layer may have a thickness of at least 8 mm and/or at most 15 mm.

The disk brake system may comprise another brake pad having any or all of the features of the brake pad described above or below. The brake pad may be configured to be pushed on by the caliper finger, while the other brake pad may be configured to be pushed on by the brake piston. The brake pad and the other brake pad may differ in size/or shape, according to some embodiments.

### BRIEF DESCRIPTION OF DRAWINGS

Exemplary embodiments will be described in conjunction with the following figures.

FIG. 1 shows a schematic view of a brake pad,

FIG. 2 shows a perspective view of the brake pad,

FIG. 3 shows a schematic cross-sectional illustration of a disk brake system,

FIGS. 4 and 5 show schematic illustrations of an inner brake pad, and

FIGS. 6 and 7 show schematic illustrations of an outer brake pad.

### DETAILED DESCRIPTION

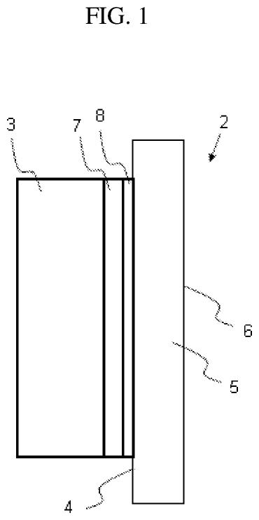

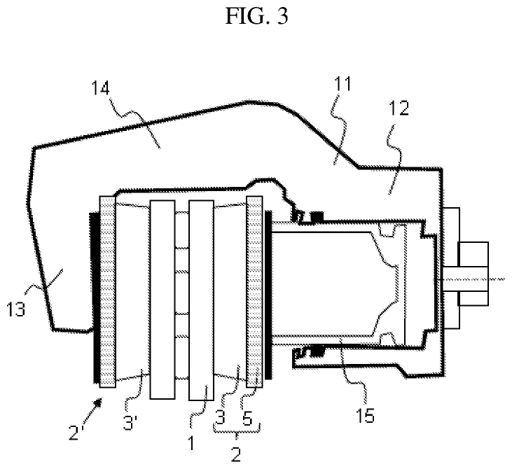

FIG. 1 shows a schematic view of a brake pad of a disk brake system of a vehicle. The disk brake system comprises a brake disk 1 (illustrated in FIG. 3) as well as a brake pad 2. The brake pad 2 has a friction layer 3, which is pushed against a friction surface of the brake disk 1 upon actuation of the disk brake system, e.g., hydraulic or electric actuation. The friction layer 3 contains a material that shows a good stopping performance and heat transfer when engaging with the brake disk 1. The friction layer 3 can have a thickness of at least 8 mm and/or at most 15 mm, for example. The material of the friction layer 3 can for instance comprise at least one of copper, iron sulphide, graphite, zinc powder, basalt, calcium carbonate, tin sulphide, zinc aluminium, phenolic resin, rubber dust and mineral fibre. These materials show good stopping performance and heat transfer when engaging with the brake disk. The friction layer 3 is indirectly connected with a front side 4 of a back plate 5, which provides structural stability to the brake pad 2. A brake piston or a caliper finger of the disk brake system is configured to push against a back surface 6 of the back plate 5 to push the friction layer 3 against the brake disk 1. An underlayer 7 is arranged between the back plate 5 and the friction layer 3. Further, an adhesive layer 8 is arranged between the underlayer 7 and the front side 4 of the back plate 5.

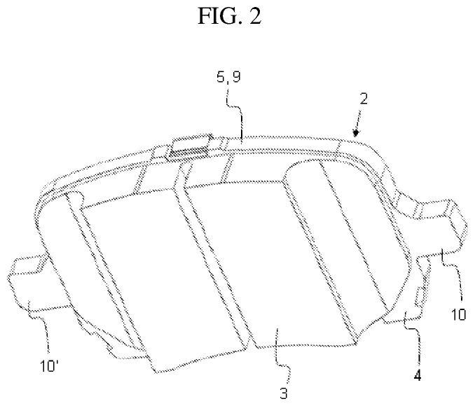

FIG. 2 shows a perspective view of the brake pad 2. Corresponding and reoccurring features shown in the different figures are denoted using the same reference numerals. The friction layer 3 of the brake pad 2 is fixed to the front side 4 of the back plate 5 (in some cases via the underlayer 7 and the adhesive layer 8). The back plate 5 comprises a back plate body 9 forming the main portion of the back plate 5 and carrying the friction layer 3. The back plate 5 further comprises a pair of guiding protrusions 10, 10′ formed at the two tangential sides of the back plate 5 and each configured to be received within a respective guiding recess of a carrier of the disk brake system. A maximal thickness of the back plate 5 may be, e.g., 5 mm.

FIG. 3 illustrates the disk brake system for a vehicle. The disk brake system includes the brake disk 1 as well as a caliper housing 11. The caliper housing 11 has an inner part 12, an outer part 13, and a bridge part 14 connecting the inner part 12 with the outer part 13. A brake piston 15 is received inside a cavity formed within the inner part 12. The cavity in the inner part 12 may be in fluid communication with a master cylinder of the disk brake system for hydraulic actuation of the disk brake system. The outer part 13 of the caliper housing 11 may be referred to as a caliper finger. The disk brake system further comprises a pair of brake pads 2, 2′. Upon application of the brake, the caliper finger 13 and the brake piston 15 push the brake pads 2, 2′ in an axial direction toward one another and toward the brake disk 1. The brake pads 2, 2′ each have a friction layer 3, 3′, which is pushed against a friction surface of the brake disk 1 upon actuation of the disk brake system. The brake piston 15 or the outer part 13 of the caliper housing 11 are configured to push against back sides of the brake pads 2, 2′ to push the friction layers 3, 3′ against the brake disk 1.

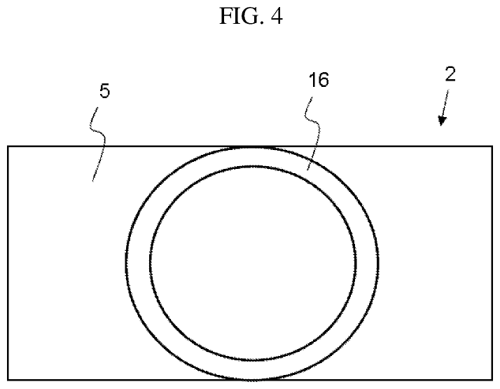

FIG. 4 is a schematic view of the inner brake pad 2 as viewed from its back side. The figure illustrates a ring-shaped region 16 of the brake pad 2, which is the region of the brake pad 2 that is configured to be pushed on by the brake piston 15 upon application of the brake. In some embodiments, the region 16 may have a circular shape.

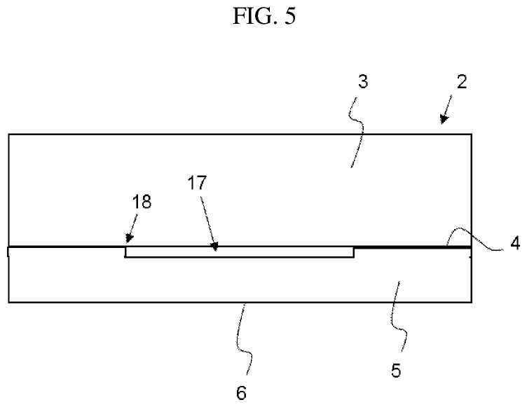

FIG. 5 shows a schematic cross-sectional view of the inner brake pad 2. As illustrated, the front side 4 of the back plate 5 comprises a recess 17 leading to an inhomogeneous thickness of the back plate 5. The recess 17 is shaped such that the back plate 5 has a reduced thickness in a part of the back plate 5 that corresponds to the region 16 of the brake pad 2 that is configured to be pushed on by the brake piston 15. The thickness of the back plate in the region 16 may be reduced by 0.8 mm as compared with other regions of the back plate 5 that are not configured to be pushed on by the brake piston 15. A step 18 separates the back plate regions of different thickness. The recess 17 may be filled by the underlayer 7 and/or by the adhesive layer 8. However, in most embodiments, the friction layer 3 has a region of increased thickness in the region 16 of the back plate 2 that is configured to be pushed on by the brake piston 15. In this case, the friction layer 3 may fill the recess 17 of the back plate 5 at least in part or even fully. The friction layer 3 and the back plate 5 may each be formed as uniform, monolithic, non-joined parts. The back side 6 of the back plate 5 is flat and stepless.

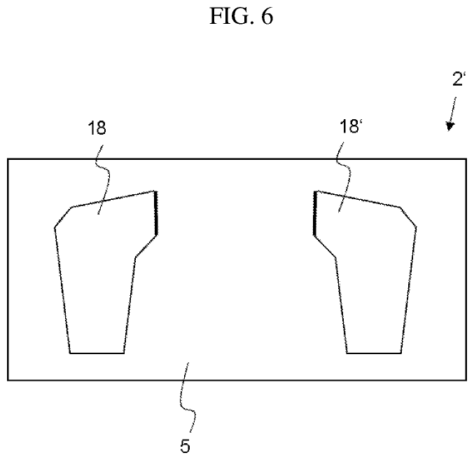

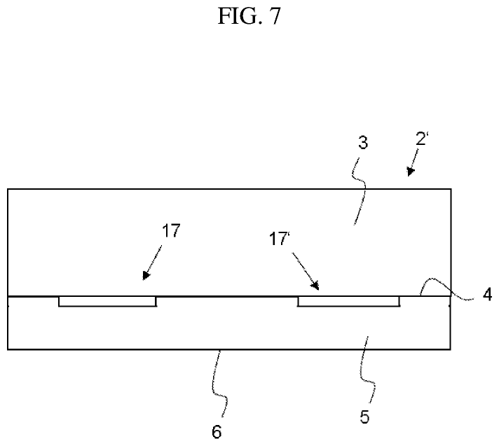

FIGS. 6 and 7 illustrate the outer brake pad 2′. As shown, in the case of the outer brake pad 2′, a pressure region that is configured to be pushed on by the caliper finger 13 is typically formed by two separate regions 18, 18′. Similar to the case of the inner brake pad 2 described above, the back plate 5 has a reduced thickness in the region 18, 18′ that is configured to be pushed on. In the case of the outer brake pad 2′, the decrease in thickness is achieved by forming a pair of recesses 17, 17′ on the front side 4 of the back plate 5. The pair of recesses 17, 17′ can be filled by the friction layer 3 in some embodiments.

Features of the different embodiments which are merely disclosed in the exemplary embodiments may be combined with one another and may also be claimed individually.

What is claimed is:

1. A brake pad for a disk brake system, comprising
a back plate having a front side for facing a brake disk of the disk brake system and
a friction layer arranged on the front side of the back plate for contacting a friction surface of the brake disk,
wherein the brake pad comprises a pressure region that is configured to be pushed on by a brake piston or by a caliper finger of the disk brake system,
wherein the back plate and the friction layer each extend into the pressure region,
characterized in that
the back plate has a reduced thickness in the pressure region as compared with a region of the brake pad that is not configured to be pushed on by the brake piston or caliper finger.

2. The brake pad of claim 1, characterized in that a thickness of the back plate in the pressure region is at least 0.4 mm smaller than in the region of the brake pad that is not configured to be pushed on by the brake piston or caliper finger.

3. The brake pad of claim 1, characterized in that a thickness of the back plate in the pressure region is at most 1.2 mm smaller than in the region of the brake pad that is not configured to be pushed on by the brake piston or caliper finger.

4. The brake pad of claim 3, characterized in that the friction layer comprises an increased thickness in the pressure region as compared with the region of the brake pad that is not configured to be pushed on by the brake piston or caliper finger.

5. The brake pad of claim 4, characterized in that a thickness of the friction layer in the pressure region is at least 0.4 mm larger than in the region of the brake pad that is not configured to be pushed on by the brake piston or caliper finger.

6. The brake pad of claim 1, characterized in that a total thickness of the back plate and the friction layer in the pressure region is the same as a total thickness of the back plate and the friction layer in the region of the brake pad that is not configured to be pushed on by the brake piston or caliper finger.

7. The brake pad of claim 1, characterized in that the back plate is formed by a non-joined part.

8. The brake pad of claim 1, characterized in that an underlayer and/or an adhesive layer is arranged between the back plate and the friction layer.

9. The brake pad of claim 1, characterized in that the back plate is made of a metal.

10. The brake pad of claim 1, characterized in that the back plate has a uniform thickness in the pressure region and/or characterized in that the back plate has a uniform thickness in the region of the brake pad that is not configured to be pushed on by the brake piston or caliper finger.

11. The brake pad of claim 1, characterized in that a shape of a surface of the front side of the back plate may result in the thickness of the back plate being reduced in the pressure region.

12. A disk brake system comprising a brake pad according to claim 1 and further comprising a carrier, wherein the brake pad is configured to slide with respect to the carrier in an axial direction upon brake application.
